(19) United States
(12) Patent Application Publication
(10) Pub. No.: US 2019/0340543 A1
(43) Pub. Date: Nov. 7, 2019

(54) SYSTEM AND METHOD FOR OPTIMIZING VEHICLE FLEET DEPLOYMENT

(71) Applicant: Fleetonomy, Ltd., Tel Aviv (IL)

(72) Inventors: Lior GERENSTEIN, Tel Aviv (IL); Israel DUANIS, Tel Aviv (IL); Alon DOURBAN, Tel Aviv (IL)

(73) Assignee: Fleetonomy, Ltd., Tel Aviv (IL)

(21) Appl. No.: 16/399,092

(22) Filed: Apr. 30, 2019

Related U.S. Application Data
(60) Provisional application No. 62/665,178, filed on May 1, 2018.

(51) Int. Cl. G06Q 10/02; G06Q 50/30; G06Q 10/04; G06Q 30/02; G08G 1/00

(52) U.S. Cl. CPC G06Q 10/02; G06Q 50/30; G08G 1/202; G06Q 30/0205; G06Q 10/04

(57) ABSTRACT

A system and method for optimizing vehicle fleet deployment. The method includes determining a predicted vehicle demand at an upcoming time for at least one geographic location based on current data including current contextual data by applying a demand prediction model to features extracted from the current data, wherein the demand prediction model is trained using machine learning based on historical vehicle demand data and historical contextual data for a plurality of historical geographical locations and times; and generating an optimal fleet movement plan based on the predicted vehicle demand by applying a linear optimization model to cost values, wherein the optimal fleet movement plan is for moving at least one vehicle of a fleet including a plurality of vehicles, wherein the cost values are determined based on the predicted vehicle demand, a current location of each vehicle of the fleet, and a status of each vehicle of the fleet.

### CROSS-REFERENCE TO RELATED APPLICATIONS

This application claims the benefit of U.S. Provisional Application No. 62/665,178 filed on May 1, 2018, the contents of which are hereby incorporated by reference.

### TECHNICAL FIELD

The present disclosure relates generally to fleet optimization, and more specifically to vehicle fleet optimization.

### BACKGROUND

Vehicle rental companies must juggle various logistical requirements to efficiently optimize deployment of fleets of vehicles such as cars, scooters, bicycles, and the like. In particular, transportation rental companies are interested in improving efficiency with respect to, for example, fuel, wear on vehicles, and the like. To this end, vehicle rental companies seek to estimate future demand. Ideally, a vehicle rental company will have the exact number of vehicles in demand available at each rental location to serve the needs of their customers. However, in reality, the distribution of vehicles rarely matches the customer demand perfectly.

Existing tracking methods include estimating future demand based on historical customer demand for each rental location of a rental company. Specifically, such existing methods may involve estimating a number of vehicles that will be needed at a particular rental location in the future based on numbers of vehicles demanded at different historical times. For example, based on historical data indicating that 10 cars were needed at a particular pick-up location on September 1 at 6:00 P.M., a future demand of 10 cars may be estimated for the same date and time.

Although these existing methods can help with anticipating rental customer needs and ensuring booked vehicles are available when required, these methods do not account for causes of demand and, thus, often result in some locations housing more vehicles than needed and others housing fewer than needed. Further, certain locations may have sufficient inventory in terms of raw numbers of vehicles but not have the right types of vehicles that may be needed. For example, a location may contain a surplus of premium vehicles while the actual demand is for lower cost vehicles.

One solution for resolving a vehicle class imbalance is for the company to offer their customers an upgrade, either for free (costing the company potential revenue from full-paying customer) or for an upgrade fee (undesirably imposing an unforeseen cost on customers). Neither solution is ideal.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for optimizing vehicle fleet deployment. The method comprises: determining a predicted vehicle demand at an upcoming time for at least one geographic location based on current data, the current data including current contextual data, wherein determining the predicted vehicle demand further comprises applying a demand prediction model to features extracted from the current data, wherein the demand prediction model is trained using machine learning based on historical data including historical vehicle demand data and historical contextual data for a plurality of historical geographical locations and times; and generating an optimal fleet movement plan based on the predicted vehicle demand for the at least one geographic location, wherein generating the optimal fleet movement plan further comprises applying a linear optimization model to at least a plurality of cost values, wherein the optimal fleet movement plan is for moving at least one vehicle of a fleet including a plurality of vehicles, wherein the plurality of cost values is determined based on the predicted vehicle demand, a current location of each vehicle of the fleet, and a vehicle status of each vehicle of the fleet.

Certain embodiments disclosed herein also include a non-transitory computer readable medium having stored thereon causing a processing circuitry to execute a process, the process comprising: determining a predicted vehicle demand at an upcoming time for at least one geographic location based on current data, the current data including current contextual data, wherein determining the predicted vehicle demand further comprises applying a demand prediction model to features extracted from the current data, wherein the demand prediction model is trained using machine learning based on historical data including historical vehicle demand data and historical contextual data for a plurality of historical geographical locations and times; and generating an optimal fleet movement plan based on the predicted vehicle demand for the at least one geographic location, wherein generating the optimal fleet movement plan further comprises applying a linear optimization model to at least a plurality of cost values, wherein the optimal fleet movement plan is for moving at least one vehicle of a fleet including a plurality of vehicles, wherein the plurality of cost values is determined based on the predicted vehicle demand, a current location of each vehicle of the fleet, and a vehicle status of each vehicle of the fleet.

Certain embodiments disclosed herein also include a system for optimizing vehicle fleet deployment. The system comprises: a processing circuitry; and a memory, the memory containing instructions that, when executed by the processing circuitry, configure the system to: determine a predicted vehicle demand at an upcoming time for at least one geographic location based on current data, the current data including current contextual data, wherein determining the predicted vehicle demand further comprises applying a demand prediction model to features extracted from the current data, wherein the demand prediction model is trained using machine learning based on historical data including historical vehicle demand data and historical contextual data for a plurality of historical geographical locations and times; and generate an optimal fleet movement plan based on the predicted vehicle demand for the at least one geographic location, wherein generating the optimal fleet movement plan further comprises applying a linear optimization model to at least a plurality of cost values, wherein the optimal fleet movement plan is for moving at least one vehicle of a fleet including a plurality of vehicles, wherein the plurality of cost values is determined based on the predicted vehicle demand, a current location of each vehicle of the fleet, and a vehicle status of each vehicle of the fleet.

### BRIEF DESCRIPTION OF THE DRAWINGS

The foregoing and other objects, features, and advantages of the disclosed embodiments will be apparent from the following detailed description taken in conjunction with the accompanying drawings.

FIG. 1 is a network diagram of the system utilized to describe various disclosed embodiments.

FIG. 2 is a block diagram of a deployment optimizer according to an embodiment.

FIG. 3 is a flowchart illustrating a method for vehicle fleet optimization according to an embodiment.

FIG. 4 is a communication diagram illustrating communications among components of an example vehicle rental fleet system.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

It has been identified that existing solutions often fail to accurately predict demand and, therefore, result in suboptimal deployment of vehicles. Specifically, since existing solutions typically only consider demand at particular times, causes of those demands are not properly accounted for when determining optimal deployment to meet demand.

Moreover, in addition to anticipating customer demand, determining ideal drop off locations (which may differ from a pick-up locations) may be necessary to ensure that demand is met. Further, considering mileage of vehicles, even within the same class, can be helpful in minimizing unnecessary wear and maximizing useable life of a vehicle. Existing solutions fail to take these factors into consideration. Finally, pricing rental reservations according to fluctuating demand based on real-time variables can be challenging to employ, especially when considering multiple locations, each with varying customer demand.

The various disclosed embodiments include a method and system for optimizing vehicle fleet deployment and, in particular, for rental implementations. A vehicle demand prediction machine learning model is trained based on historical vehicle and contextual data. Once trained, the demand prediction machine learning mode is applied to anticipated future vehicle and contextual data in order to generate a vehicle demand prediction. The predicted vehicle demand includes, but is not limited to, a number of vehicles needed for each of one or more geographical locations, and may further include types of vehicles, amounts of fuel, or other vehicle characteristics required to meet the predicted vehicle demand.

In an embodiment, based on the predicted demand for each geographic location, a current supply at each vehicle location, and a location of each vehicle, an optimal fleet movement plan is created. The optimal fleet movement plan includes plans for moving one or more vehicles of the fleet. To this end, a linear optimization model is applied to the predicted demands, current supplies, and locations, in order to output movement plans for vehicles of the fleet. The linear optimization model is further based on one or more vehicle efficiency factors for each vehicle such as, but not limited to, fuel, power, wear, time until next maintenance, method of transportation (e.g., driven by person as compared to being moved by a flatbed truck), and the like.

The optimal fleet movement plan provides increased efficiency of vehicle utilization. Specifically, vehicles are moved such that the effective lifespans of vehicles are increased, the duration of a current deployment is maximized, use of fuel or power is minimized, or a combination thereof. To this end, the linear optimization model is configured such that vehicles are moved in order to minimize distances traveled, to reduce wear on vehicles that have shorter remaining lifespans, to reduce instances of vehicles running out of fuel or power during rentals, combinations thereof, and the like. Thus, the linear optimization model provides a fleet movement plan that optimizes efficiency with respect to these factors, thereby minimizing use of fuel or power as well as extending longevity of vehicles by ensuring that vehicles are not subject to excessive wear. In some implementations, the linear optimization model may be further based on expected revenue for movements.

In some implementations, an optimal price for a rental reservation is also determined based on rental location and the predicted vehicle demand. In some implementations, a shift plan may be created based on the predicted vehicle demand and information related to potential vehicle pilots (e.g., employees of a rental company). To this end, the predicted vehicle demand as well as potential pilot constraints (e.g., with respect to active times, authorization to drive certain vehicles or types of vehicles, etc.) are utilized to generate a shift plan for each team member including piloting a specific vehicle to one or more locations at one or more corresponding times for each location.

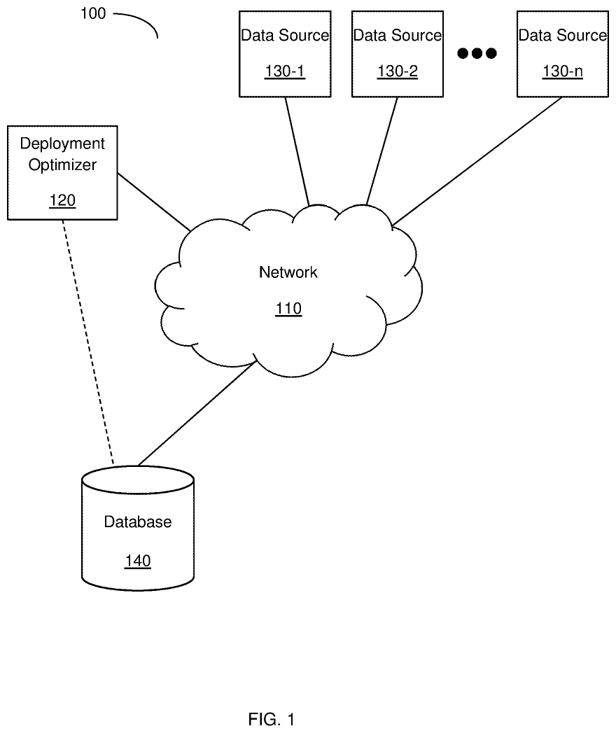

FIG. 1 is an example network diagram 100 utilized to describe various disclosed embodiments. The network diagram 100 includes a deployment optimizer 120, one or more data sources 130-1 to 130-n (hereinafter a “data source 130” or “data sources 130” for simplicity) and a database 140 communicating via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

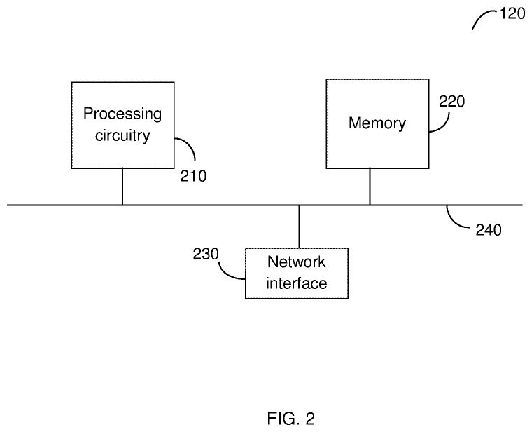

The deployment optimizer 120 includes a processing circuitry and a memory, for example as described with respect to FIG. 2. The deployment optimizer 120 is configured to generate optimal fleet movement plans including movement plans for one or more vehicles of a fleet. The fleet is a group of vehicles, each of which may be any vehicle such as, but not limited to, a car, a truck, a scooter, a bicycle, a motorcycle, and the like. In an example implementation, the fleet of vehicles is owned by a rental company and is used to provide ride sharing services or vehicle sharing services (e.g., car, bike, or scooter sharing services).

The data sources 130 store data used for optimizing vehicle deployment such as, but not limited to, vehicle demand data (e.g., historical demand at various locations and times); contextual data (e.g., weather reports and event schedules); or both. The data sources 130 may be regularly updated with relevant information to ensure that the deployment optimizer 120 has access to the most recent relevant data. For example, the weather data may be accessed from a weather forecasting website on a regular basis and rental records may be updated daily or hourly based on the internal reservation system of rental company.

The locations may be fixed locations or changing locations. As a non-limiting example, for a vehicle rental service, locations at which vehicles may be deployed include a fixed set of locations of rental properties. As another non-limiting example, for a car sharing service, locations at which vehicles may be deployed include any locations in which vehicles have historically been deployed as indicated in the historical data.

The database 140 contains a storage (not shown). In an embodiment (not shown), the database 140 is directly connected to the deployment optimizer 120. The database 140 may include customer profiles, historical rental information for individual rental office locations, current vehicle status data, and the like. The current vehicle status data may include, but is not limited to, location, amount of fuel or power remaining, age, remaining effective lifespan, time until next maintenance, combinations thereof, and the like.

The deployment optimizer 120 may use the information stored in the database 140 such as, for example, by retrieving a profiles of customers. Such information may include, but is not limited to, frequency of rentals, distribution of rental locations used by the customer, preferred vehicle class level, age, driving history, and so on.

Based on data retrieved from the data sources 130 and the database 140, the deployment optimizer 120 is configured to generate an optimal fleet movement plan that provides optimal deployment of one or more vehicles of a fleet. The optimal fleet movement plan may include moving vehicles to standby locations at which vehicles should wait or otherwise move to in order to meet anticipated future demand. The standby locations may include fixed locations or changing locations, for example locations that were indicated in the historical data. The locations may be subject to constraints such as, for example, limitations on the number of vehicles that may be deployed at each location (e.g., locations with less parking or other space for vehicles may have lower limits than locations with more vehicle space). To this end, the deployment optimizer 120 may be configured with rules restricting vehicle deployment based on such location limits.

In some implementations, the deployment optimizer 120 may be further configured to determine a suggested rental price or rental price adjustment that should be assigned to one or more of the vehicles. In an embodiment, the deployment optimizer 120 is configured to send the optimal fleet movement plan, for example, to a server of a rental company (e.g., one of the data sources 130).

FIG. 2 is a block diagram of a deployment optimizer 120 according to an embodiment.

The deployment optimizer 120 includes a processing circuitry 210, a memory 220, and a network interface 230. In an embodiment, the components of the deployment optimizer 120 may be connected via a bus 240.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in a storage (not shown).

The memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein.

The network interface 230 allows the deployment optimizer to communicate with, for example, the database 140, one or more of the data sources 130, both, and the like.

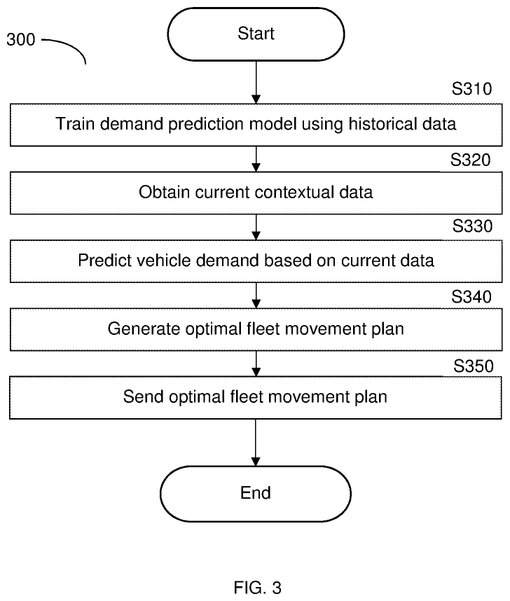

FIG. 3 is an example flowchart 300 illustrating a method for optimizing vehicle fleet deployment according to an embodiment. In an embodiment, the method is performed by the deployment optimizer 120, FIG. 1.

At S310, a demand prediction model is trained applying a machine learning algorithm to training data including historical data. The demand prediction model is configured to predict future demand at an upcoming time for particular types of vehicles at upcoming dates and locations based on current contextual data.

The historical data includes at least historical vehicle demand data as well as historical contextual data. In an embodiment, S310 may include preprocessing the real-time data. Such preprocessing may include, but is not limited to, normalizing the data, deriving features from raw data, or both. In particular, historical data obtained from sources having different data formats may be normalized into a unified format. In an example implementation, the demand prediction model may be trained using machine learning techniques including regression and neural networks.

The historical vehicle demand data includes data indicating demand for vehicles with corresponding locations and time data. The demand may include, but is not limited to, numbers of vehicles demanded of each type, length of rental, both, and the like. The vehicle types may be defined with respect to, for example, make and model, premium or regular, numbers of available passenger seats, and other factors that may reflect more specific vehicle demands than numbers of vehicles alone. The historical vehicle demand data may further include data indicating an amount of fuel or power required for servicing the demand (e.g., an amount of fuel or power used by vehicles sent to the respective locations).

The contextual data includes supplementary data in addition to time and location that may affect demand at particular times and locations. To this end, such contextual data may include, but is not limited to, numbers of booked reservations, traffic conditions at or around pickup locations, weather conditions and forecasts, event schedules (e.g., related to social or other gatherings such as concerts, sports games, movie showtimes, etc.), non-fleet transportation data (e.g., flight schedules), lodging data (e.g., hotel bookings and availability).

At S320, current contextual data is obtained. The current contextual data may include kinds of data included in the historical contextual data as described above. In a further embodiment, the current contextual data may include currently anticipated data indicating anticipated context at a time and location. In at least some implementations and circumstances, using currently anticipated data may provide more accurate predictions of demand than using current data. Future contextual data includes forecasted variables such as, but not limited to, weather, and future customer behaviors (e.g., anticipated increases or decreases in demand to promotions or discounts).

At S330, a future vehicle demand is predicted based at least on current contextual data using the demand prediction model. To this end, S330 includes applying the demand prediction model to features extracted from the current contextual data as well as locations and times for which demand should be predicted. In an embodiment, the future vehicle demand indicates a number of vehicles of each type needed at one or more future times for one or more of the geographic locations.

At S340, an optimal fleet movement plan is generated based on the predicted vehicle demand and current locations of vehicles of the fleet.

The optimal fleet movement plan provides an optimal deployment of vehicles with respect to the predicted vehicle demand such that each of one or more locations is assigned a number of vehicles of each type that will meet the predicted vehicle demand. To this end, the optimal fleet movement plan includes one or more vehicle movement plans indicating where each vehicle should be moved, for example, “move vehicle having identifier 12345 to location L,” where L is a geographic location (for example, a location expressed using navigation coordinates). Vehicles that are already in the optimal deployment location may not have a movement plan generated or a movement plan for such vehicles may be, for example, “do not move at this time.”

In an embodiment, generating the optimal fleet movement plan includes applying a linear optimization model to minimize costs associated with moving vehicles to meet the predicted demand. Such costs may be in the form of fuel consumption, power consumption, wear, combinations thereof, and the like. To this end, inputs to a cost function utilized for the linear optimization model include, but are not limited to, identifiers for each vehicle of the fleet, a current location of each vehicle of the fleet, destination locations and their respective predicted demands, potential methods of transportation for each vehicle (e.g., move by pilot or move by flatbed truck), mileage, age, time until next maintenance. The linear optimization model is configured with cost values or functions for determining cost values based on these inputs.

The inputs to the linear optimization model may be enriched with data related to predicted future behavior such as, but not limited to, predicted use of vehicles of the fleet, predicted user preferences, and the like. Such inputs may be determined using machine learning models trained based on historical user behavior (i.e., of users renting or riding in vehicles). The predicted user behavior may include, but is not limited to, mileage per trip, whether returns will be early or late, and the like. The predicted user preferences include preferences such as, but not limited to, make and model, color, ancillary required features (e.g., child seat, ski rack, bicycle rack, etc.), and the like. The machine learning models related to predicted future behavior may be trained using training sets including historical behavior and corresponding locations and times.

The inputs to the linear optimization model may be further enriched with supplemental data related to pending vehicle reservations by users such as, but not limited to, customer loyalty tier of a user requesting a vehicle, vehicle class of a requested vehicle, requested reservation length, upgrade priority, and the like.

In a further embodiment, the linear optimization model may also consider net value with respect to the costs mentioned above. The net value is determined as the expected revenue minus costs associated with vehicle movements, penalties for not matching customer expectations (e.g., not having the type of vehicle reserved by a customer available at the time of a pickup), and holding costs for an idle fleet. Movement actions may include directing a rental customer to return a vehicle to a rental office different from the one at which the vehicle was picked up from. Additionally, movement actions may include moving vehicles from one lot to another internally, e.g., employees driving the vehicles rather than customers. To this end, the linear optimization model may be further applied to maximize revenue based on predicted revenue for, e.g., ride or vehicle sharing services.

Considering current and destination locations allows for applying distance traveled as a cost of the linear optimization model, thereby generating a plan that moves vehicles of the fleet so as to minimize fuel and power consumption. Considering factors such as fuel or power consumption, maintenance, and mileage, allows for deployment of vehicles so as to distribute driven miles more equally across a fleet in order to maximize effective lifespans of vehicles in the fleet (i.e., time until a vehicle is retired from use) as well as maximizing effective performance time (e.g., time before the next event that would require the vehicle to be temporarily withdrawn from use such as due to refueling, charging, or maintenance). Further, certain vehicles may be tagged as approaching a predetermined mile or age amount, where a rental company policy may call for the retirement of a vehicle from their fleet, or a reduction in usage so as not to exceed vehicle mileage and age limits, e.g., limits set for conformation within a vehicle ‘buyback’ program.

In an embodiment, machine learning may be further utilized in generating the optimal fleet movement plan. Specifically, a machine learning model may be trained to determine cost values based on the inputs to the linear optimization model, which in turn are utilized to perform the linear optimization.

The machine learning may include a Seasonal Autoregressive Integrated Moving Average (SARIMA) model, and a Recurrent Neural Network (RNN) model. The SARIMA model may be fitted to a daily reservations time series with respect to a reservations segment. The daily reservations time series is characterized with long term seasonal patterns over months, a weekly pattern according to the weekday, and dependency between successive days. These patterns result in a non-stationary time series. The SARIMA model is adjusted to factor in these patterns and to fit a transformed, stationary time series for forecasting future daily reservations. In order to further reduce the variance and non-stationarity effects of the daily reservations time series, the SARIMA model can be fit to the time series of the ratio between reservations that were booked in more than a week advance to the total daily reservations.

The RNN model may be implemented to capture a wide range of explanatory variables with complex inner interactions. The unique strength of an RNN model compared to other Neural Networks is its ability to relate to long term patterns aside to short term patterns. With the RNN model, the daily reservations can be predicted based on explanatory variables such as temperature, rainfall, holidays, and incoming flights to the fleet site's nearest airport.

A prediction module may be employed to forecast future rentals for a given time period based on vehicle class and location on an hourly or daily rate. The prediction module may include expected revenue for each vehicle based on the determined real-time and historical data. The data used may further include unutilized vehicles (vehicles which are not allocated to any reservation within a set time frame) and unmatched reservations (reservations which have not been assigned with any particular vehicle). Thus, the prediction module may provide values related to revenue for implementations in which the linear optimization further includes maximizing revenue.

In an embodiment, the linear optimization model may be subject to one or more constraints. In an example implementation, such constraints include prioritizing certain rental scenarios. For example, confirmed reservations can be considered as “must serve at any cost” (e.g., requiring vehicle movements to meet demand including confirmed reservations even when such movements would not minimize costs), moving vehicles to meet predicted demand that is not met by current supply may only be determined optimal if the sum of revenue for the reservation is higher than movement costs, and the like.

In some implementations, recommended movement actions (e.g., moving a vehicle from one location to another) may require confirmation via a user interface, e.g., a website or internal application. Any recommended movement actions that are not met within, for example, a certain period of time, may be excluded from consideration as part of the optimal fleet movement plan.

In an embodiment, S340 may further include assigning suggested prices to vehicles of the fleet. The suggested prices may be based on general vehicle availability, vehicle type availability, predicted customer demand, time and date of pick-up and drop off, and the like. Further, the suggested prices may be based on results of the linear optimization algorithm, including accounting for costs.

At optional S350, the optimal fleet movement plan is sent for utilization. In an embodiment, the optimal fleet movement plan is sent to, for example, to a server of a vehicle rental company. For example, the optimal price may be communicated to a web server configured to control pricing on an internal network or on a publicly available access point, e.g., a public facing website. In another embodiment, the optimal fleet movement plan is sent to a system configured to at least partially control vehicles of the fleet (e.g., a command and control server used for sending commands to autonomous vehicles).

The optimal fleet movement plan may be further relayed to an internal system in order to suggest optimized drop off locations of vehicles to maintain the desired vehicle and vehicle class numbers of each rental office location. The optimal fleet movement plan may be communicated to multiple end points, for example rental locations, such that each location has the most up to date distribution and pricing information. The cycle of updating may be predetermined or adjustable. For example, the optimal fleet movement plan may be determined and communicated to the internal network twice a day, or on an hourly basis.

In an embodiment, the optimal fleet movement plan is determined and communicated to a rental system a predetermined number of hours or days in advance of the anticipated future demand in order to allow the upcoming reservations to be adjusted based on the determined optimal distribution. For example, the optimal fleet distribution may be communicated 72 hours in advance to allow for reservations to accommodate the predicted distribution of demand. The optimal fleet movement plan may continue to be updated in the interim.

In some implementations, the optimal fleet movement plan may be utilized to adapt to actual demand based on planned supplies of vehicles at various locations or otherwise provide more information to rental systems. To this end, in an embodiment, S350 may further include adjusting one or more rentals based on actual demand or determining such information. Various examples of adjusting rentals or providing more information to rental systems follow.

When a customer arrives at a rental location to rent a reserved vehicle, it may be determined whether an appropriate vehicle (i.e., the reserved vehicle or a matching class vehicle meeting the requirements of the reserved vehicle with respect to vehicle type) is available based on the vehicle status and current location information. If not, an appropriate switch, upgrade, or downgrade may be assigned. A matching class may include a size of vehicle, luxury status, transmission type, and the like. If no appropriate vehicle is available, an upgrade of the next available class is requested. If no upgrade is available, a downgrade is requested.

In scenarios involving an undersupply of rental vehicles, a determination may be made between two or more customers regarding which vehicle may be assigned to each customer. For example, if two customers have reserved the same class of vehicle for pick-up on the same day, but only one vehicle within that class is available and an upgraded vehicle is available, it may be determined that a customer having loyalty status is assigned the upgraded vehicle. If neither, or both customers, have loyalty status, a customer with more frequent rentals may be assigned the upgrade. Alternatively, the customers may be offered a choice of available vehicles to rent in place of the reserved one, with or without a price adjustment to the rental.

In addition to the optimal pricing and distribution determinations, additional information may be communicated to the rental system. For example, expected vehicle shortages or surpluses, recommended transport actions, visualization of the usage of vehicles as an overview for an individual location or for selected vehicles (e.g., via graphs or other media over user interfaces), statistics about additional value through movements, and sets of key performance indicators (KPIs) (acceptance level of vehicle assignments and movement proposals etc.) may each be communicated to the rental system such that individual rental location can access such data.

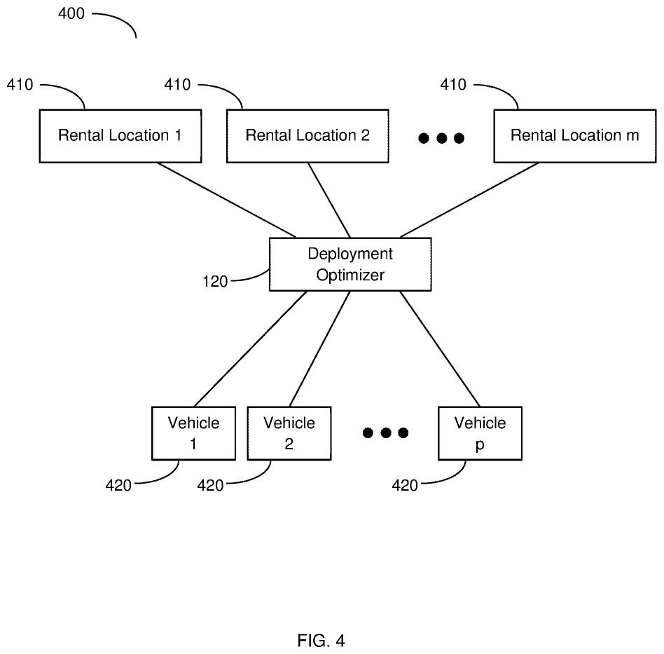

FIG. 4 is a communication diagram 400 illustrating an example deployment of a vehicle fleet. The communication diagram 400 includes the deployment optimizer 120, communicating with rental locations 410-1 through 410-m and with vehicles 420-1 through 420-p. The deployment optimizer 120 is configured to track various parameters associated with the vehicles 420, including class, location, mileage, age, maintenance schedule, and the like. Further, the deployment optimizer 120 is configured to track various parameters associated with the rental locations 410, including demand within the service area, number of vehicles currently and anticipated to be housed at the rental location, and the like.

The deployment optimizer 120 is configured to determine optimal fleet movement plans for meeting predicted future demand. For example, if rental location 1 is determined to have excess inventory of rental vehicles to meet predicted future and is located within a close proximity to rental location 2 which does not have sufficient inventory of rental vehicles to meet predicted future demand, the deployment optimizer 120 may determine that a set number of vehicles from certain classes should be moved from rental location 1 to rental location 2. This determination may be relayed to an internal network such that the relevant reservations may be updated with the new drop off location. The movements may further be utilized to minimize distance traveled, use of fuel or power by vehicles that would exhaust their fuel or power supplies, reduce wear on vehicles having shorter remaining effective lifespans, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for optimizing vehicle fleet deployment, comprising:
determining a predicted vehicle demand at an upcoming time for at least one geographic location based on current data, the current data including current contextual data, wherein determining the predicted vehicle demand further comprises applying a demand prediction model to features extracted from the current data, wherein the demand prediction model is trained using machine learning based on historical data including historical vehicle demand data and historical contextual data for a plurality of historical geographical locations and times;
generating an optimal fleet movement plan based on the predicted vehicle demand for the at least one geographic location, wherein generating the optimal fleet movement plan further comprises applying a linear optimization model to at least a plurality of cost values, wherein the optimal fleet movement plan is for moving at least one vehicle of a fleet including a plurality of vehicles, wherein the plurality of cost values is determined based on the predicted vehicle demand, a current location of each vehicle of the fleet, and a vehicle status of each vehicle of the fleet.

2. The method of claim 1, wherein the vehicle status of each vehicle of the fleet includes at least one of: an amount of fuel remaining, an amount of power remaining, mileage, and time until next maintenance.

3. The method of claim 2, wherein the optimal fleet movement plan provides an optimal effective lifespan of the fleet.

4. The method of claim 2, wherein the optimal fleet movement plan provides an optimal effective performance time of the fleet.

5. The method of claim 1, wherein the predicted vehicle demand indicates a number of vehicles of each of at least one type of vehicle that are required for each of the at least one geographic location.

6. The method of claim 1, wherein the linear optimization model is further applied to a revenue value for each geographic location, wherein the linear optimization model is configured to provide optimal net value with respect to the plurality of cost values and the at least one revenue value.

7. The method of claim 1, wherein the historical vehicle demand data further includes at least one of: amounts of fuel needed, and amounts of power needed.

8. A non-transitory computer readable medium having stored thereon instructions for causing a processing circuitry to execute a process, the process comprising:
determining a predicted vehicle demand at an upcoming time for at least one geographic location based on current data, the current data including current contextual data, wherein determining the predicted vehicle demand further comprises applying a demand prediction model to features extracted from the current data, wherein the demand prediction model is trained using machine learning based on historical data including historical vehicle demand data and historical contextual data for a plurality of historical geographical locations and times;
generating an optimal fleet movement plan based on the predicted vehicle demand for the at least one geographic location, wherein generating the optimal fleet movement plan further comprises applying a linear optimization model to at least a plurality of cost values, wherein the optimal fleet movement plan is for moving at least one vehicle of a fleet including a plurality of vehicles, wherein the plurality of cost values is determined based on the predicted vehicle demand, a current location of each vehicle of the fleet, and a vehicle status of each vehicle of the fleet.

9. A system for vehicle fleet optimization, comprising:
a processing circuitry; and
a memory, the memory containing instructions that, when executed by the processing circuitry, configure the system to:
determine a predicted vehicle demand at an upcoming time for at least one geographic location based on current data, the current data including current contextual data, wherein determining the predicted vehicle demand further comprises applying a demand prediction model to features extracted from the current data, wherein the demand prediction model is trained using machine learning based on historical data including historical vehicle demand data and historical contextual data for a plurality of historical geographical locations and times;
generate an optimal fleet movement plan based on the predicted vehicle demand for the at least one geographic location, wherein generating the optimal fleet movement plan further comprises applying a linear optimization model to at least a plurality of cost values, wherein the optimal fleet movement plan is for moving at least one vehicle of a fleet including a plurality of vehicles, wherein the plurality of cost values is determined based on the predicted vehicle demand, a current location of each vehicle of the fleet, and a vehicle status of each vehicle of the fleet.

10. The system of claim 9, wherein the vehicle status of each vehicle of the fleet includes at least one of: an amount of fuel remaining, an amount of power remaining, mileage, and time until next maintenance.

11. The system of claim 10, wherein the optimal fleet movement plan provides an optimal effective lifespan of the fleet.

12. The system of claim 10, wherein the optimal fleet movement plan provides an optimal effective performance time of the fleet.

13. The system of claim 9, wherein the predicted vehicle demand indicates a number of vehicles of each of at least one type of vehicle that are required for each of the at least one geographic location.

14. The system of claim 9, wherein the linear optimization model is further applied to a revenue value for each geographic location, wherein the linear optimization model is configured to provide optimal net value with respect to the plurality of cost values and the at least one revenue value.

15. The system of claim 9, wherein the historical vehicle demand data further includes at least one of: amounts of fuel needed, and amounts of power needed.
